(19) United States
(12) Patent Application Publication
(10) Pub. No.: US 2026/0036882 A1
(43) Pub. Date: Feb. 5, 2026

(54) DIAL DEVICE AND IMAGING APPARATUS

(71) Applicant: FUJIFILM Corporation, Tokyo (JP)

(72) Inventors: Yangbae Ji, Saitama-shi (JP); Takeo Hyodo, Saitama-shi (JP)

(73) Assignee: FUJIFILM Corporation, Tokyo (JP)

(21) Appl. No.: 19/276,017

(22) Filed: Jul. 22, 2025

(30) Foreign Application Priority Data
Jul. 31, 2024 (JP) 2024-124243
Dec. 20, 2024 (JP) 2024-225475

(51) Int. Cl. G03B 17/02; H04N 23/51

(52) U.S. Cl. CPC G03B 17/02; H04N 23/51

(57) ABSTRACT

A dial device of an imaging apparatus, includes: a first rotating member, a second rotating member, and a third rotating member that are arranged along a first axis, and at least the second rotating member and the third rotating member are disposed in an opening portion provided in a housing of the imaging apparatus.

### CROSS-REFERENCE TO RELATED APPLICATIONS

The present application claims priority under 35 U.S.C. § 119 to Japanese Patent Application No. 2024-124243 filed on Jul. 31, 2024, and Japanese Patent Application No. 2024-225475 filed on Dec. 20, 2024. The above applications are hereby expressly incorporated by reference, in those entirety, into the present application.

### BACKGROUND OF THE INVENTION

### 1. Field of the Invention

The present invention relates to a dial device and an imaging apparatus.

### 2. Description of the Related Art

JP2018-132545A discloses an electronic apparatus comprising a first rotational operation member that are coaxially disposed and can be rotated independently, a second rotational operation member, and a third rotational operation member, in which the first rotational operation member is exposed to an exterior portion of a camera and is rotatably fitted and supported on a first fixing member, the first fixing member is provided integrally with an upper surface-side cover, the second fixing member is connected to a lower end of the first fixing member, and the second rotational operation member and the third rotational operation member are rotatably supported between the first fixing member and the second fixing member in a state in which a part of the second rotational operation member and the third rotational operation member is exposed to the exterior in a circumferential direction.

JP2024-031733A discloses an electronic apparatus comprising a rotation operation unit that includes a first rotation operation member and a second rotation operation member which are coaxially disposed and can be independently rotated, in which the rotation operation unit includes a pair of first click mechanisms that impart a tactile click to the first rotation operation member and a pair of second click mechanisms that impart a tactile click to the second rotation operation member.

JP1994-023137U (JP-H06-023137U) describes a multi-stage rotary switch comprising a first rotational operation knob, a second rotational operation knob, and a third rotational operation knob that are coaxially disposed and can be independently rotated, in which switch contacts are collectively disposed on one printed wiring board.

### SUMMARY OF THE INVENTION

One embodiment according to the technology of the present disclosure provides a dial device and an imaging apparatus that can suppress an increase in size of an apparatus.

(1)

A dial device of an imaging apparatus, comprising: a first rotating member, a second rotating member, and a third rotating member that are arranged along a first axis, in which at least the second rotating member and the third rotating member are disposed in an opening portion provided in a housing of the imaging apparatus.

(2)

The dial device according to (1), further comprising: a base member; a first holder member that is fastened to the base member along the first axis; and a second holder member and a third holder member that are fastened to the first holder member along the first axis, in which the second rotating member is held by the first holder member and the second holder member, and the third rotating member is held by the second holder member and the third holder member.

(3)

The dial device according to (1) or (2), further comprising: a click mechanism that imparts a tactile click to a rotation operation of the second rotating member.

(4)

The dial device according to (3), in which the click mechanism includes an elastic member and a sphere, and the elastic member and the sphere are arranged along the first axis in a hole portion of the second rotating member.

(5)

The dial device according to any one of (1) to (4), in which the second rotating member includes a first gear portion, and the dial device further comprises: a gear member that includes a second gear portion that is engaged with the first gear portion, and a shaft portion that is arranged along a second axis; and a first detector that detects rotation of the shaft portion.

(6)

The dial device according to (5), in which, in a view in a direction of the first axis, the third rotating member has an outer peripheral surface along a circle centered on the first axis, and the shaft portion has an overlapping portion with the circle.

(7)

The dial device according to (5) or (6), further comprising: a wall member formed along the first gear portion and the second gear portion.

(8)

The dial device according to any one of (1) to (7), in which the opening portion is provided on a front surface of the housing.

(9)

The dial device according to (8), in which a grip portion that is gripped by a user is provided on a front surface of the housing, and the opening portion is provided to include at least a part of the grip portion.

(10)

The dial device according to any one of (1) to (9), in which the second rotating member and the third rotating member are provided on a bottom surface side of the housing with respect to a top surface of the housing.

(11)

The dial device according to any one of (1) to (10), in which, in a view in a direction of the first axis, at least a part of an outer peripheral portion of the second rotating member and at least a part of an outer peripheral portion of the third rotating member are disposed to be exposed from the opening portion.

(12)

The dial device according to (11), in which, in a view in a direction of the first axis, a portion of the outer peripheral portion of the second rotating member, which is exposed from the opening portion, is less than half of the outer peripheral portion of the second rotating member, and a portion of the outer peripheral portion of the third rotating member, which is exposed from the opening portion, is less than half of the outer peripheral portion of the third rotating member.

(13)

The dial device according to (12), in which, in a view in a direction of the first axis, a portion of the outer peripheral portion of the second rotating member, which is exposed from the opening portion, is less than ¼ of the outer peripheral portion of the second rotating member, and a portion of the outer peripheral portion of the third rotating member, which is exposed from the opening portion, is less than ¼ of the outer peripheral portion of the third rotating member.

(14)

The dial device according to (1), in which, in a view in a direction of the first axis, portions of the first rotating member, the second rotating member, and the third rotating member, which are exposed from the opening portion, have arc shapes that are concentric and that have the same diameter.

(15)

The dial device according to (14), in which the first rotating member is a member that rotates a finite number of times, the second rotating member is a member that rotates infinitely, and the third rotating member is a member that rotates a finite number of times.

(16)

The dial device according to any one of (1) to (15), in which the second rotating member is shielded in a view in a direction of the first axis.

(17)

An imaging apparatus comprising: the dial device according to any one of (1) to (16).

(18)

A dial device of an imaging apparatus, comprising: a first rotating member and a second rotating member that are arranged along a first axis, in which the first rotating member and the second rotating member are disposed in an opening portion provided in a housing of the imaging apparatus.

According to the present invention, it is possible to provide a dial device and an imaging apparatus capable of suppressing an increase in size of the device.

### BRIEF DESCRIPTION OF THE DRAWINGS

FIG. 1 is a front view schematically showing an example of an imaging apparatus 1 according to the present embodiment.

FIG. 2 is a front view showing an example of a right dial lever 5 in the present embodiment.

FIG. 3 is a view of the right dial lever 5 as viewed from above.

FIG. 4 is a perspective view of the right dial lever 5 as viewed from an upper left side.

FIG. 5 is a perspective view showing an opening portion 7 in a state in which a first rotating member 20, a second rotating member 40, and a third rotating member 60 are detached.

FIG. 6 is a cross-sectional view taken along a first axis X1 of a right dial lever 5.

FIG. 7 is a perspective view showing an inner 42 of the second rotating member 40.

FIG. 8 is a perspective cross-sectional view showing a first gear portion 50 of an inner 42.

FIG. 9 is a side view showing the first gear portion 50 and the second gear portion 52.

FIG. 10 is a view of the gear member 51 and the third rotating member 60 as viewed from below.

### DESCRIPTION OF THE PREFERRED EMBODIMENTS

Hereinafter, an example of an embodiment of the present invention will be described with reference to the drawings. In the present embodiment, the terms “upward direction”, “downward direction”, “leftward direction”, “rightward direction”, “forward direction”, and “backward direction” are used, but these directions are relative directions set for convenience of description of the imaging apparatus 1 and the right dial lever 5 of the imaging apparatus 1 shown in the drawing.

### Imaging Apparatus of Embodiment

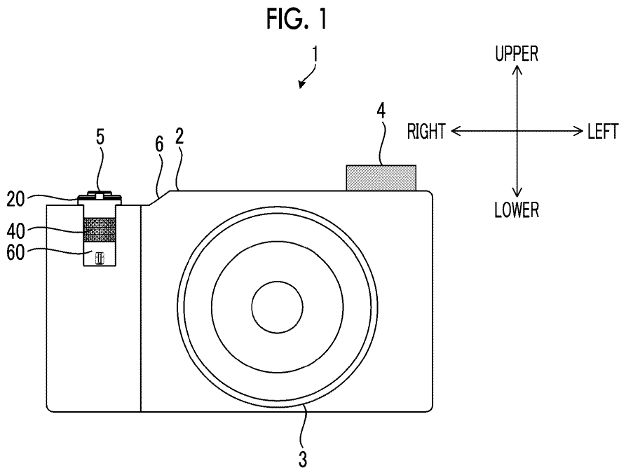

FIG. 1 is a front view schematically showing an example of an imaging apparatus 1 according to the present embodiment. As shown in FIG. 1, examples of an imaging apparatus include a single-lens reflex camera and a digital camera. The imaging apparatus 1 comprises a housing 2, an imaging lens 3, a left dial lever 4, and a right dial lever 5.

The imaging lens 3 is provided at a front portion (front side) of the housing 2. The imaging lens 3 is attachable to and detachable from the housing 2. A plurality of types of imaging lenses 3 are interchangeably attached to the housing 2.

The left dial lever 4 is a dial lever provided on an upper left side of the housing 2. The right dial lever 5 is a dial lever provided on an upper right side of the housing 2. The left dial lever 4 and the right dial lever 5 are used as, for example, dial levers for switching and setting an imaging mode of the imaging apparatus 1. In addition, the left dial lever 4 and the right dial lever 5 may be used as dial levers for setting a shutter speed, an international organization for standardization (ISO) sensitivity, an aperture, and the like of the imaging apparatus 1. The left dial lever 4 and the right dial lever 5 are examples of a “dial device” in the present invention.

The right dial lever 5 includes a first rotating member 20, a second rotating member 40, and a third rotating member 60. The first rotating member 20, the second rotating member 40, and the third rotating member 60 are rotating members having a substantially cylindrical shape. The first rotating member 20, the second rotating member 40, and the third rotating member 60 are provided in an up-down direction. In addition, the first rotating member 20, the second rotating member 40, and the third rotating member 60 are provided in a state in which a part of each of the first rotating member 20, the second rotating member 40, and the third rotating member 60 is exposed to the front surface side of the housing 2. Further, the first rotating member 20 is provided in a state where an upper portion of the first rotating member 20 protrudes upward from a top surface of the housing 2. The second rotating member 40 and the third rotating member 60 are provided on a bottom surface side of the housing 2 from a top surface of the housing 2. The “top surface” is a surface on the upper side of the imaging apparatus 1 in the sideway capturing posture of the imaging apparatus 1. The “bottom surface” is a surface on the lower side of the imaging apparatus 1 in the sideway capturing posture of the imaging apparatus 1. That is, the second rotating member 40 and the third rotating member 60 in the right dial lever 5 are provided in a state of not protruding above the top surface.

In addition, in a case where the imaging apparatus 1 is viewed in a front view, a step 6 is provided on the top surface of the housing 2. The step 6 is provided such that a position of a top surface of a region where the left dial lever 4 and the imaging lens 3 are provided is higher than a position of a top surface of a region where the right dial lever 5 is provided. By providing the step 6, a position of an upper end of the first rotating member 20 protruding upward from the top surface of the housing 2 is configured to be a position equal to or slightly lower than a position of the top surface of the region where the left dial lever 4 and the imaging lens 3 are provided. Accordingly, the imaging apparatus 1 can be reduced in size.

### Dial Device of Embodiment

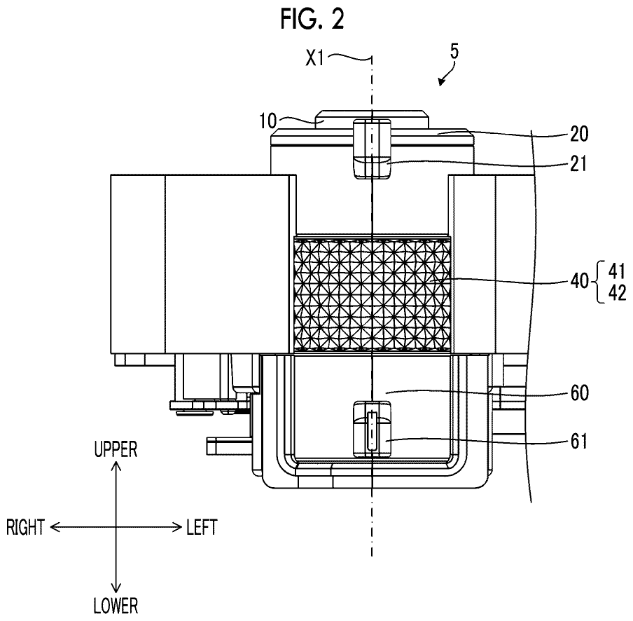

FIG. 2 is a front view showing an example of the right dial lever 5 in the present embodiment. As shown in FIG. 2, a release button 10 is provided at an upper end portion of the right dial lever 5. The release button 10 is provided at an upper end portion of the right dial lever 5. The release button 10, the first rotating member 20, the second rotating member 40, and the third rotating member 60 are arranged along a first axis X1 extending in the up-down direction. The first axis X1 is an axis extending in the up-down direction in the sideway capturing posture of the imaging apparatus 1.

Among the first rotating member 20, the second rotating member 40, and the third rotating member 60, the first rotating member 20 is a rotating member disposed on the uppermost side. The second rotating member 40 is a rotating member disposed below (in the middle of) the first rotating member 20. The third rotating member 60 is a rotating member disposed on a lower side (the lowest side) of the second rotating member 40. The right dial lever 5 is a three-stage dial lever having three rotating members (the first rotating member 20, the second rotating member 40, and the third rotating member 60).

The first rotating member 20 is a rotating member including a protruding power lever 21 provided on an outer peripheral portion. The first rotating member 20 is rotatable about the first axis X1 by operating, for example, a power lever 21. The power of the imaging apparatus 1 is turned on by setting the power lever 21 to, for example, ON, and the power is turned off by setting the power lever 21 to OFF. The power lever 21 is disposed above the top surface of the housing 2. The power lever 21 is a lever that rotates a finite number of times.

The second rotating member 40 is a rotating member including a command dial 41 and an inner member 42. The command dial 41 can perform exposure correction, shutter speed setting, set value change of a quick menu, program shift adjustment, F number setting, image setting during playback, and the like. The inner is disposed inside the command dial 41 and rotates together with the command dial 41. The command dial 41 is a dial that rotates infinitely.

The third rotating member 60 is a rotating member including a protruding digital teleconverter lever 61 provided on an outer peripheral portion. The third rotating member 60 is rotatable about the first axis X1 by operating, for example, the digital teleconverter lever 61. The digital teleconverter lever 61 can switch, for example, the enlarged image of the different focal length to the imaging by the digital super-resolution processing. The digital teleconverter lever 61 is a lever that rotates a finite number of times.

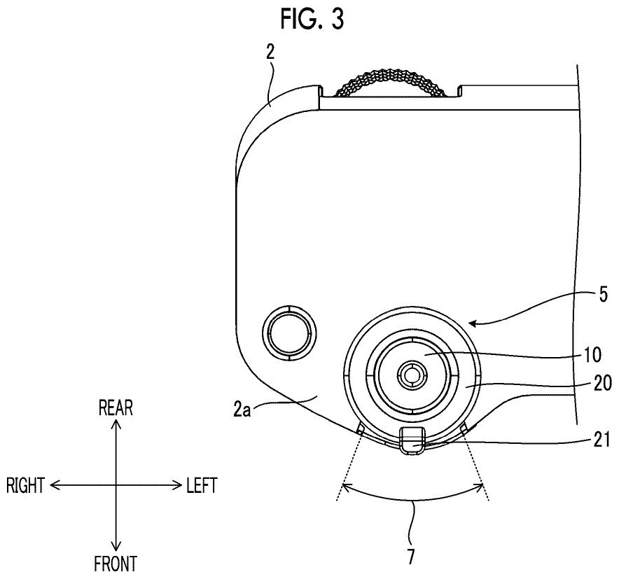

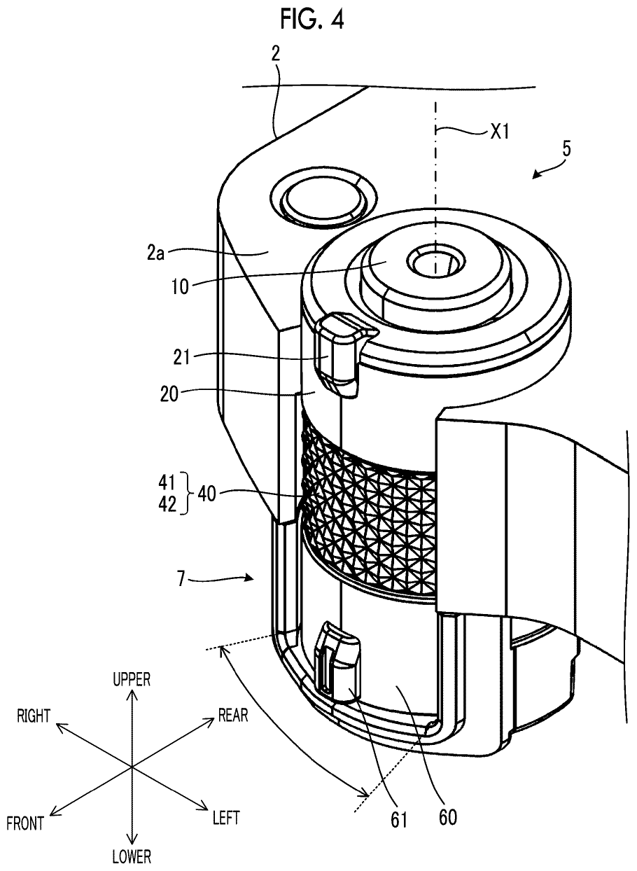

FIG. 3 is a view of the right dial lever 5 as viewed from above. FIG. 4 is a perspective view of the right dial lever 5 as viewed from the upper left side. As shown in FIGS. 3 and 4, the right dial lever 5 is provided on the front surface side in the upper right region of the housing 2.

In addition, an opening portion 7 is provided on a front surface of the housing 2. The “front surface” is a surface on the front side (subject side) at the time of imaging. The opening portion 7 is a portion that is open toward the outside (side) of the housing 2. The opening portion 7 is formed in a rectangular shape, for example, from the top surface to the bottom surface on the front surface of the housing 2.

In addition, a grip portion 2a that is gripped by a user is provided on a front surface of the housing 2. The “grip portion 2a” is a portion that is bulged on the front side so that the user can easily grip the grip portion 2a with a hand during imaging. The opening portion 7 is provided to include at least a part of the grip portion 2a that is elevated on the front side.

The first rotating member 20, the second rotating member 40, and the third rotating member 60 are disposed in the opening portion 7. The term “disposed at the opening portion 7” means that the opening portion 7 is disposed to be exposed to the outside of the housing 2. In a view in the direction of the first axis X1, at least a part of an outer peripheral portion of the first rotating member 20, the second rotating member 40, and the third rotating member 60 is disposed to be exposed from the opening portion 7. The outer peripheral portions of the first rotating member 20, the second rotating member 40, and the third rotating member 60 exposed from the opening portion 7 have a shape along an outer edge of a portion (for example, a curved portion) that is bulged toward the front side of the grip portion 2a.

In the first rotating member 20, the second rotating member 40, and the third rotating member 60, portions other than exposed portions are disposed in the housing 2. However, as described above, in a case where the rotating members stacked in three stages are viewed in the up-down direction, the first rotating member 20 at the top is disposed such that an upper part of the first rotating member 20 protrudes upward from the top surface of the housing 2, and the second rotating member 40 in the middle and the third rotating member 60 at the bottom are disposed below the top surface of the housing 2. The second rotating member 40 in the right dial lever 5 is shielded in a view in the direction of the first axis X1. The term “shielded” means that the imaging apparatus 1 is provided in a state of being completely invisible or almost invisible by being shielded by the top surface of the housing 2 or other members of the imaging apparatus 1, such as the first rotating member 20.

In a view in the direction of the first axis X1, a portion of the outer peripheral portion of the second rotating member 40 exposed from the opening portion 7 is less than half of the outer peripheral portion of the second rotating member 40. In addition, a portion of the outer peripheral portion of the third rotating member 60 exposed from the opening portion 7 is less than half of the outer peripheral portion of the third rotating member 60. The “half of the outer peripheral portion” is that the length of the exposed portion of the outer peripheral line of the rotating member is half of the length of the entire outer peripheral line. In addition, in a view in the direction of the first axis X1, a portion of the outer peripheral portion of the second rotating member 40 exposed from the opening portion 7 may be less than 1/4 of the outer peripheral portion of the second rotating member 40. In addition, a portion of the outer peripheral portion of the third rotating member 60 exposed from the opening portion 7 may be less than 1/4 of the outer peripheral portion of the third rotating member 60.

In the first rotating member 20, the second rotating member 40, and the third rotating member 60, a portion exposed from the opening portion 7 in each rotating member is provided in a concentric and arc shapes that are concentric and that have the same diameter in a view in a direction of the first axis X1. The “arc shapes that are concentric and that have the same diameter” includes a substantially circular arc shape having a substantially the same center and a substantially the same diameter. For example, although the outer peripheral surface of the second rotating member 40 is provided with fine unevenness, a member having such a shape is also included.

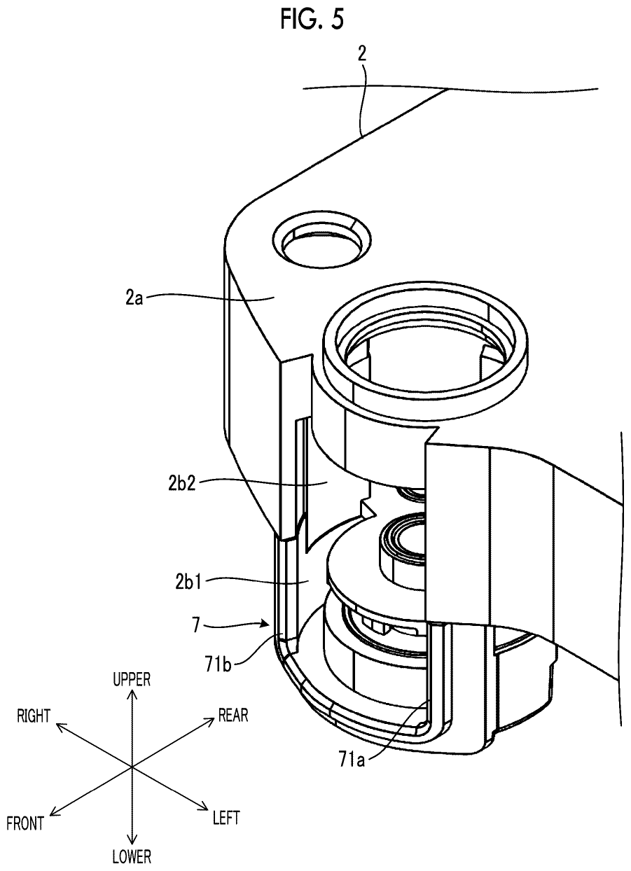

FIG. 5 is a perspective view showing the opening portion 7 in a state in which the first rotating member 20, the second rotating member 40, and the third rotating member 60 are detached. As shown in FIG. 5, wall members 2b1 and 2b2 having a shape surrounding the first rotating member 20, the second rotating member 40, and the third rotating member 60 are provided inside the housing 2. The wall members 2b 1 and 2b2 are formed in a circular arc shape surrounding the rotating member with the left end portion 71a and the right end portion 71b of the opening portion 7 as a starting point or an end point.

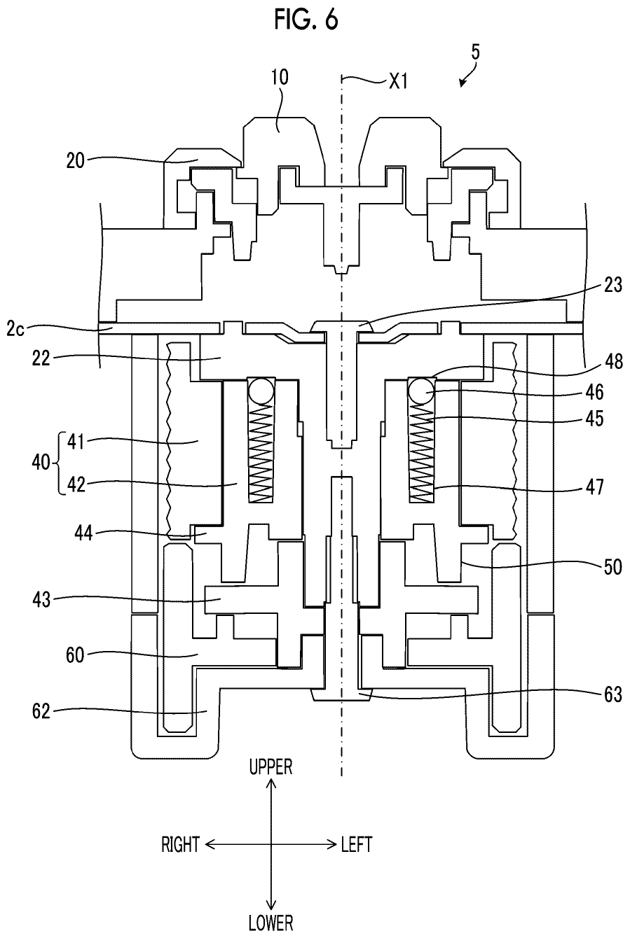

FIG. 6 is a cross-sectional view of the right dial lever 5 taken along a first axis X1. As shown in FIG. 6, a release button 10 is attached to the right dial lever 5 on the upper side of the first rotating member 20. In addition, the right dial lever 5 is provided with a base member 2c that holds the position of the right dial lever 5, a first holder member 22 that is fastened to the base member 2c, and a second holder member 43 and a third holder member 62 that are fastened to the first holder member 22.

The first holder member 22 is fastened to the base member 2c along the first axis X1 by fastening members such as screws 23. The second holder member 43 and the third holder member 62 are fastened to the first holder member 22 along the first axis X1 by fastening members such as screws 63. The second holder member 43 and the third holder member 62 are fixed to the base member 2c via the first holder member 22. The base member 2c is fixed to the housing 2. Alternatively, the base member 2c may be a part of the housing 2.

The second rotating member 40 is held by the first holder member 22 and the second holder member 43. The third rotating member 60 is held by the second holder member 43 and the third holder member 62. The second rotating member 40 is rotatable around the first holder member 22. The third rotating member 60 is rotatable around the second holder member 43.

The command dial 41 of the second rotating member 40 is composed of a metal member. The inner 42 of the second rotating member 40 is composed of a resin member. The inner 42 is attached to the inside of the command dial 41 by press-fitting or adhesion. The inner 42 rotates around the first holder member 22 together with the command dial 41. The inner 42 is provided with a stopper portion 44 that is locked to the command dial 41 and that is used to secure a gap between the second rotating member 40 (command dial 41) and the third rotating member 60. The third rotating member 60 is formed of a metal member, similarly to the command dial 41. By providing the stopper portion 44 in the inner 42 in this way, it is possible to prevent rubbing between the command dial 41 of the second rotating member 40 and the third rotating member 60. Accordingly, the drip-proof performance into the housing 2 can be enhanced.

In addition, the second rotating member 40 is provided with a click mechanism that imparts a tactile click to the rotation operation of the second rotating member 40. The click mechanism includes, for example, an elastic member 45 consisting of a spring and a sphere 46 consisting of a ball. The elastic member 45 and the sphere 46 are disposed in the hole portion 47 formed in the inner 42 in the vertical direction along the first axis X1. The hole portion 47 in which the elastic member 45 and the sphere 46 are disposed is formed at positions facing each other with the first axis X1 interposed therebetween in the circumferential direction of the inner 42. The first holder member 22 is provided to be in contact with the upper side of the inner 42, and a plurality of recess portions 48 are provided on the first holder member 22 at predetermined intervals in the circumferential direction. The recess portion 48 is provided to be engageable with the sphere 46.

The click mechanism is configured such that the sphere 46 disposed in the hole portion 47 of the inner 42 abuts on the first holder member 22 due to the biasing of the elastic member 45. In a case where the second rotating member 40 is rotated, the position of the hole portion 47 in which the elastic member 45 and the sphere 46 are disposed is sequentially moved in the rotation direction, and thus the recess portion 48 that is engaged with the sphere 46 biased by the elastic member 45 is sequentially changed with the movement of the hole portion 47. The tactile click is a response given to the user at a specific rotation angle (for example, a periodic rotation angle) with respect to the rotation operation of the second rotating member 40. For example, the tactile click is an operational feeling in which the force required for the rotation is repeatedly increased and decreased with respect to the rotation amount of the second rotating member 40.

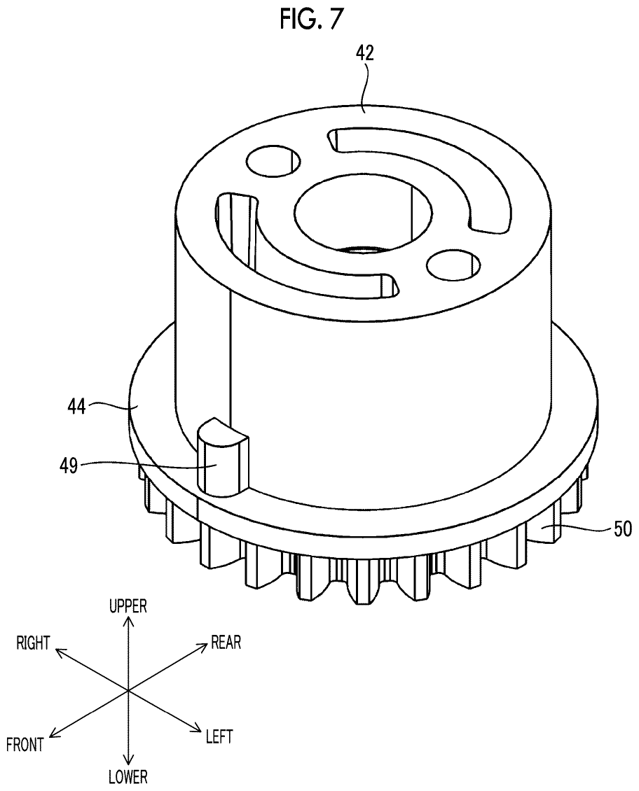

FIG. 7 is a perspective view showing the inner 42 of the second rotating member 40. As shown in FIG. 7, the inner 42 has a substantially cylindrical shape. The inner 42 is provided with a stopper portion 44 and a protrusion portion 49. The stopper portion 44 is a visor-like portion provided on the lower portion of the inner 42 over the entire periphery, and is a portion that is locked to the command dial 41 as described above. The protrusion portion 49 is a protruding portion provided on the outer peripheral portion of the inner 42 and is fitted into a hole portion formed inside the command dial 41. The protrusion portion 49 is fitted into the hole portion of the command dial 41, and thus the inner 42 rotates around the first holder member 22 together with the command dial 41. In addition, a first gear portion 50 is provided at a lower end portion of the inner 42. The first gear portion 50 is a gear-shaped portion provided at a lower end portion of the inner 42.

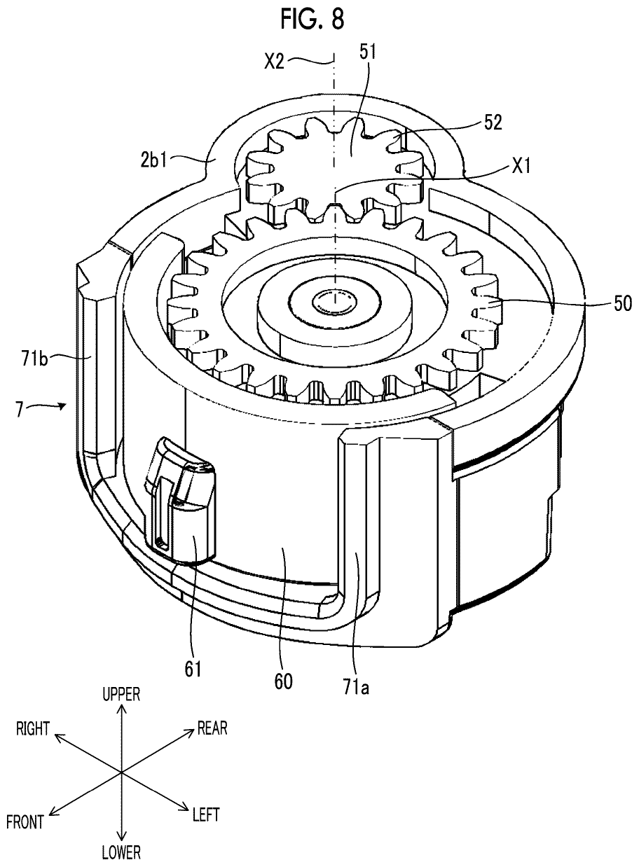

FIG. 8 is a perspective cross-sectional view showing the first gear portion 50 of the inner 42. As shown in FIG. 8, the first gear portion 50 of the inner 42 is disposed on the rear side of the third rotating member 60. A gear member 51 consisting of a member different from the inner 42 is provided adjacent to the first gear portion 50 (in the present example, the right rear side). The gear member 51 has a second gear portion 52 that engages with the first gear portion 50 of the inner 42. The size of the gear member 51 is smaller than the size of the gear member of the inner 42 having the first gear portion 50. The gear member 51 rotates about the second axis X2. The second axis X2 of the gear member 51 is an axis parallel to the first axis X1 of the inner 42. A wall member 2b1 is formed along the first gear portion 50 and the second gear portion 52 in the first gear portion 50 and the second gear portion 52. The wall member 2b1 is the wall member described in FIG. 5, and is formed with a left end portion 71a and a right end portion 71b of the opening portion 7 as a starting point or an end point.

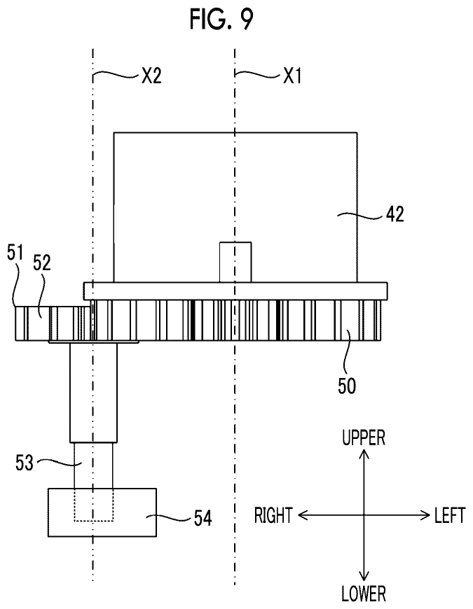

FIG. 9 is a side view showing the first gear portion 50 and the second gear portion 52. As shown in FIG. 9, the gear member 51 is disposed next to the inner 42 by engaging the second gear portion 52 with the first gear portion 50 of the inner 42. The gear member 51 has a shaft portion 53 arranged along the second axis X2. An encoder 54 that detects the rotation of the shaft portion 53 is provided in the shaft portion 53. The encoder 54 detects the rotation of the inner 42 (second rotating member 40) by detecting the rotation of the shaft portion 53 of the gear member 51. The encoder 54 is an example of a “first detector” in the present invention.

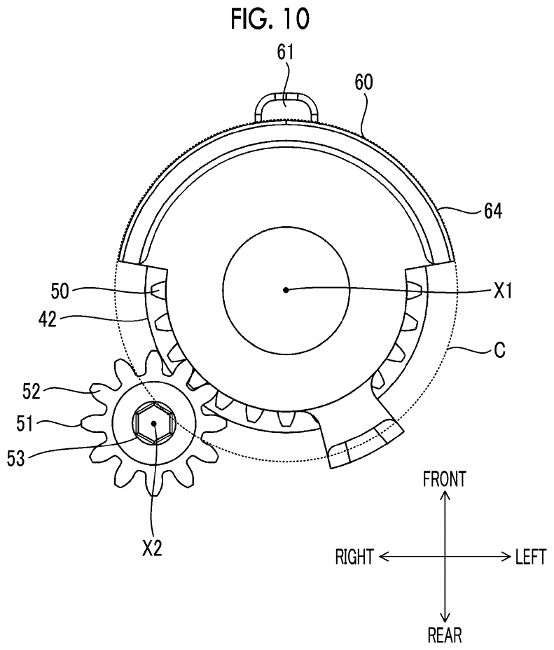

FIG. 10 is a view of the gear member 51 and the third rotating member 60 as viewed from below. As shown in FIG. 10, in a view in a direction of the first axis X1, the third rotating member 60 has an outer peripheral surface 64 along a circle C centered on the first axis X1. The circle C is an imaginary circle about the first axis X1. The outer peripheral surface 64 is an outer peripheral portion of a part of the third rotating member 60 exposed from the opening portion 7 of the housing 2. In a view in the direction of the first axis X1, the shaft portion 53 arranged along the second axis X2 of the gear member 51 is provided such that a part of the shaft portion 53 overlaps the circle C.

In the above-described embodiment, the right dial lever 5 is described as the dial device, but the present invention is not limited thereto. The configuration of the dial device described above may be applied to the left dial lever 4.

As described above, the right dial lever of the present embodiment comprises the first rotating member 20, the second rotating member 40, and the third rotating member 60 that are arranged along the first axis X1, and at least the second rotating member 40 and the third rotating member 60 are disposed in the opening portion 7 that is provided to be open toward the outside of the housing 2 of the imaging apparatus 1. The second rotating member 40 and the third rotating member 60 disposed in the opening portion 7 are disposed below the top surface of the housing 2, and are disposed such that a part of the outer peripheral portion is exposed to the outside of the housing 2 from the opening portion 7. In a case of a three-stage structure dial lever having three rotating members, the size in the direction (longitudinal direction) of the first axis X1, which is the rotation axis, becomes large (long). On the other hand, as in the present configuration, by disposing at least the second rotating member 40 and the third rotating member 60 in the housing 2, it is possible to suppress an increase in the size of the housing 2 in the longitudinal direction of the region where the right dial lever 5 is provided. Accordingly, even in a case where the right dial lever 5 having a three-stage structure is mounted, an increase in size of the imaging apparatus 1 can be suppressed.

In addition, since the second rotating member 40 and the third rotating member 60 are disposed such that a part of the outer peripheral portion is exposed to the outside of the housing 2 from the opening portion 7, the user can easily operate the second rotating member 40 and the third rotating member 60 from the opening portion 7 even in a case where the second rotating member 40 and the third rotating member 60 are disposed in the housing 2.

In addition, in the three-stage rotating member, the second rotating member 40 (command dial) is disposed below the first rotating member 20 (power lever). In a case where the second rotating member 40 (command dial) and the third rotating member 60 (teleconverter lever) are compared, the command dial has a higher frequency of use than the teleconverter lever. Therefore, it is easier for the user to operate the command dial in a case where the command dial is disposed next to the power lever (immediately below the power lever) in a case where the user operates the power lever with the index finger and operates the command dial by lowering the index finger or in a case where the user operates the command dial with the middle finger.

In addition, in the right dial lever 5, the second rotating member 40 and the third rotating member 60 are disposed in an opening portion 7 provided on the front surface of the housing 2. A grip portion 2a of the imaging apparatus 1 that is gripped by a user is provided on the front surface of the housing 2, and the opening portion 7 is provided to include at least a part of the grip portion 2a. According to this configuration, since the opening portion 7 is formed in the grip portion 2a that is bulged on the front side of the housing 2, the outer peripheral portions of the second rotating member 40 and the third rotating member 60 exposed from the opening portion 7 are exposed in a shape along the bulging shape of the grip portion 2a. Therefore, even in a case of the second rotating member 40 and the third rotating member 60 disposed in the housing 2, the user can easily operate the second rotating member 40 and the third rotating member 60 exposed from the opening portion 7 while gripping the grip portion 2a.

In addition, since the opening portion 7 is formed in the grip portion 2a that is bulged on the front side, even in a case where the portions of the second rotating member 40 and the third rotating member 60 exposed from the opening portion 7 are, for example, less than half and further less than ¼ of the outer peripheral portions of the second rotating member 40 and the third rotating member 60, the second rotating member 40 and the third rotating member 60 can be easily operated from the opening portion 7.

In addition, the right dial lever 5 comprises a first holder member 22 that is fastened to the base member 2c along the first axis X1, and a second holder member 43 and a third holder member 62 that are fastened to the first holder member 22 along the first axis X1, and the second rotating member 40 is held by the first holder member 22 and the second holder member 43, and the third rotating member 60 is held by the second holder member 43 and the third holder member 62. According to this configuration, since the second rotating member 40 and the third rotating member 60 are positioned along the same first axis X1, concentric accuracy of the rotating member can be improved.

In addition, the right dial lever 5 has a click mechanism including an elastic member 45 and a sphere 46 that impart a tactile click to the rotation operation of the second rotating member 40, and the elastic member 45 and the sphere 46 are arranged along the first axis X1 in a hole portion 47 provided in the inner 42 of the second rotating member 40. As described above, by disposing the elastic member 45 and the sphere 46 in the hole portion 47 of the inner 42, it is possible to suppress an increase in size (height) of the second rotating member 40 in the first axis X1 direction, and it is possible to reduce the size of the right dial lever 5.

In addition, the right dial lever 5 includes a first gear portion 50 that is provided at a lower portion of the inner 42 of the second rotating member 40, a gear member 51 that includes a second gear portion 52 and a shaft portion 53 arranged along the second axis X2 as a member that engages with the first gear portion 50 of the inner 42, and an encoder 54 as a device that detects rotation of the shaft portion 53. Then, in a view in the direction of the first axis X1, the third rotating member 60 has an outer peripheral surface 64 along a circle C about the first axis X1, and the shaft portion 53 of the gear member 51 that engages with the first gear portion 50 of the inner 42 is disposed to have an overlapping portion with the circle C. According to this configuration, the small gear member 51 that engages with the first gear portion 50 of the inner 42 is provided next to (on the side of) the first gear portion 50, and the rotation amount of the second rotating member 40 (command dial) can be detected by detecting the rotation amount of the gear member 51. Therefore, since an encoder that directly detects the rotation of the second rotating member 40 (command dial) does not need to be provided in the command dial, it is possible to suppress an increase (lengthening) in the size of the right dial lever 5 in the first axis X1 direction (longitudinal direction).

In addition, the right dial lever 5 is provided with wall members 2b1 and 2b2 having a shape that surrounds the first rotating member 20, the second rotating member 40, the third rotating member 60, the first gear portion 50, and the second gear portion 52. According to this configuration, it is possible to prevent dust, water droplets, and the like that have entered from the opening portion 7 from further entering the housing 2 deeper than the right dial lever 5.

### EXPLANATION OF REFERENCES

1: imaging apparatus
2: housing
2a: grip portion
2b1, 2b2: wall member
2c: base member
3: imaging lens
4: left dial lever
5: right dial lever
6: step
7: opening portion
10: release button
20: first rotating member
21: power lever
22: first holder member
23, 63: screw
40: second rotating member
41: command dial
42: inner
43: second holder member
44: stopper portion
45: elastic member
46: sphere
47: hole portion
48: recess portion
49: protrusion portion
50: first gear portion
51: gear member
52: second gear portion
53: shaft portion
54: encoder
60: third rotating member
61: digital teleconverter lever
62: third holder member
64: outer peripheral surface
71a: left end portion
71b: right end portion
X1: first axis
X2: second axis

What is claimed is:

1. A dial device of an imaging apparatus, comprising:
a first rotating member, a second rotating member, and a third rotating member that are arranged along a first axis,
wherein at least the second rotating member and the third rotating member are disposed in an opening portion provided in a housing of the imaging apparatus.

2. The dial device according to claim 1, further comprising:
a base member;
a first holder member that is fastened to the base member along the first axis; and
a second holder member and a third holder member that are fastened to the first holder member along the first axis,
wherein the second rotating member is held by the first holder member and the second holder member, and
the third rotating member is held by the second holder member and the third holder member.

3. The dial device according to claim 1, further comprising:
a click mechanism configured to impart a tactile click to a rotation operation of the second rotating member.

4. The dial device according to claim 3,
wherein the click mechanism includes an elastic member and a sphere, and
the elastic member and the sphere are arranged along the first axis in a hole portion of the second rotating member.

5. The dial device according to claim 1,
wherein the second rotating member includes a first gear portion, and the dial device further comprises:
a gear member that includes a second gear portion that is engaged with the first gear portion, and a shaft portion that is arranged along a second axis; and
a first detector that detects rotation of the shaft portion.

6. The dial device according to claim 5,
wherein, in a view in a direction of the first axis, the third rotating member has an outer peripheral surface along a circle centered on the first axis, and
the shaft portion has an overlapping portion with the circle.

7. The dial device according to claim 5, further comprising:
a wall member formed along the first gear portion and the second gear portion.

8. The dial device according to claim 1,
wherein the opening portion is provided at a front surface of the housing.

9. The dial device according to claim 8,
wherein a grip portion that is to be gripped by a user is provided on the front surface of the housing, and
the opening portion is provided to include at least a part of the grip portion.

10. The dial device according to claim 1,
wherein the second rotating member and the third rotating member are provided on a bottom surface side of the housing with respect to a top surface of the housing.

11. The dial device according to claim 1,
wherein, in a view in a direction of the first axis, at least a part of an outer peripheral portion of the second rotating member and at least a part of an outer peripheral portion of the third rotating member are disposed to be exposed from the opening portion.

12. The dial device according to claim 11,
wherein, in the view in the direction of the first axis, a portion of the outer peripheral portion of the second rotating member, which is exposed from the opening portion, is less than half of the outer peripheral portion of the second rotating member, and
a portion of the outer peripheral portion of the third rotating member, which is exposed from the opening portion, is less than half of the outer peripheral portion of the third rotating member.

13. The dial device according to claim 12,
wherein, in the view in the direction of the first axis, the portion of the outer peripheral portion of the second rotating member, which is exposed from the opening portion, is less than ¼ of the outer peripheral portion of the second rotating member, and
the portion of the outer peripheral portion of the third rotating member, which is exposed from the opening portion, is less than ¼ of the outer peripheral portion of the third rotating member.

14. The dial device according to claim 1,
wherein, in a view in a direction of the first axis, portions of the first rotating member, the second rotating member, and the third rotating member, which are exposed from the opening portion, have arc shapes that are concentric and that have a same diameter.

15. The dial device according to claim 14,
wherein the first rotating member is a member that rotates a finite number of times,
the second rotating member is a member that rotates infinitely, and
the third rotating member is a member that rotates a finite number of times.

16. The dial device according to claim 1,
wherein the second rotating member is shielded in a view in a direction of the first axis.

17. An imaging apparatus comprising:
the dial device according to claim 1.

18. A dial device of an imaging apparatus, comprising:
a first rotating member and a second rotating member that are arranged along a first axis,
wherein the first rotating member and the second rotating member are disposed in an opening portion provided in a housing of the imaging apparatus.
